(19) United States
(12) Patent Application Publication
(10) Pub. No.: US 2008/0158041 A1
(43) Pub. Date: Jul. 3, 2008

(54) Airport Surface Detector and Control System

(75) Inventors: Raoul Candidi Tommasi Crudeli, Udine (IT); Raffaele Douglas Candidi Tommasi Crudeli, Udine (IT)

Correspondence Address: ST. ONGE STEWARD JOHNSTON & REENS, LLC, 986 BEDFORD STREET, STAMFORD, CT, 06905-5619, US

(73) Assignee: Tommasi & Tommasi America, LLC, Baltimore, MD (US)

(21) Appl. No.: 11/618,428

(22) Filed: Dec. 29, 2006

(51) Int. Cl. G01S 13/00

(52) U.S. Cl. 342/36; 701/300; 703/22

(57) ABSTRACT

An airport surface detector and control system to detect aircraft, vehicles, and other objects moving on concerned pathways of the airport, including at least a Central Processing Unit and Central Surveillance/Control Unit. The system comprises at least a laser-scanning head at the entry of the pathways, and able to cooperate to identify the moving object on its pathway, integrated by a plurality of ground laser-detector units distributed along the pathway and placed one in front of the other. Each ground detector unit contains at least a laser emitter or a laser receiver and one laser ray is emitted from each head against the other head, in a parallel close way, in order to be able to detect interruption of one and/or the other laser-ray.

### FIELD OF THE INVENTION

The present invention relates to an Airport Surface Detector and Control System.

### BACKGROUND OF THE INVENTION

### State of the Art

A review of major existing technologies in this field will be proposed in the following paragraphs. Most of these technologies have been approved by the FAA and/or ICAO.

### Surface Radar Technologies

Surface radar systems have been in use in many airports, and have proved to be an interesting solution, although they bear very high prices, both for installation and maintenance, so they are acceptable only for very large airports. Smaller airports (up to 3-4 runways) cannot afford surface radar.

### Identification Technologies

Over the years many active and passive identification methods and systems have been proposed and—to some extent—applied.

The passive systems require the cooperation of aircrafts and vehicles, which are supposed to send some data to the ATC, while active systems try to identify the type of aircraft or vehicle without the object's cooperation. There are even hybrid technologies or systems which accept extensions and integrations.

### Secondary Surveillance Radar

SSR's are radar interrogators in use at ATC's in order to track aircraft provided with a transponder. They can operate in several modes: Mode 1-2-3-4-5, mode A, C and mode S. Civilian flights are permitted (and/or required) by ICAO to use mode A, C and S only, while other modes are reserved for military aircraft.

### Mode S

The mode-S is a protocol specification defined in Annex 10 of the ICAO for the individual interrogation of aircraft either from ATC's or other planes. It has been developed in order to avoid the clutter deriving from broadcast-only interrogations.

Mode S relies on a unique 24-bit ID assigned to each aircraft. This ID number encodes the make and model of the aircraft, the operating airline, the flight number, flying height, status, and so on.

The transmission takes place on two different frequencies (1030 and 1090 MHz).

The pilot can decide to disable the 24 bit code in part or entirely, per NATO requirements.

Mode S is designed to be operated in conjunction with a SSR mode S sensor.

### ASD-B

The Automatic Dependent Surveillance-Broadcast (in short ASD-B) is used by aircraft to broadcast information about their status over radio. The transmitted data contains the category of the plane, its current position (derived by the GPS) and altitude, airspeed, and current maneuver, and can reach a range of about 200 miles.

ASD-B data can be read by ATC (ASD-B out), or by other planes (ASD-B in). The latter modality is currently being adopted by major aircraft manufacturers, but the majority of existing planes will still be unable to receive information about surrounding planes.

Another modality is the ASD-C extension, which allows for data transmission over a satellite link.

### Traffic Information Services-Broadcast (TIS-B)

The TIS-B is a transponder-based system to aid pilots in the process of visual acquisition of other aircrafts. TIS-B is limited to in-air operation and works only if all the planes have a properly working transponder.

### Flight Information Services-Broadcast (FIS-B)

This service is broadcast from ground stations and provides aircraft with weather and flight information over an ASD/UAT data link. Traffic alert and Collision Avoidance System (TCAS)

TCAS is a transponder-based device used to avoid mid-air collisions with other aircrafts. TCAS do not rely on ATC, and represent an implementation of the ICAO ACAS (Airborne Collision Avoidance System) equipment. ACAS are mandatory for aircrafts over 5.700 kg or approved for carrying more than 19 passengers.

### Cockpit Display of Traffic Information (CDTI)

CDTI are a class of monitor-like displays used on board in order to show information transmitted by automatic auxiliary services (such as TIS-B, FIS-B, ASD-B, ASD-C, etc.).

### SUMMARY OF THE INVENTION

### SCOPE OF THE PRESENT INVENTION

The scope of the present invention is to develop a system in order to address several safety concerns about airport surface traffic in a reliable way and at a contained cost.

These concerns include the need to:
know if something is present or moving on runways and taxiways;
identify the type of entity (aircraft, truck, person, mammal, etc.);
measure the speed and direction of that entity;
identify the size and/or the model of the airplane;
prevent collisions between aircrafts and other entities;
prevent intrusions of any entity on runways and taxiways;
alert the Control Tower and/or the pilot(s) to the presence of other aircraft and entities;
provide a cost-effective solution.

As stated above, there are several technologies which can perform at least some of the above-listed tasks, but they are very expensive and/or do not provide full coverage for all moving objects on the airport surface. Since only a few major airports can afford to invest so much money in safety systems, the vast majority of airports don't have a surface safety system.

Furthermore, several well-known ICAO protocols are in use or planned, but only apply to a fraction of aircraft, leaving the rest with no protection whatsoever and leaving the ATC with a significant lack of information and Decision Support Systems.

### DISCLOSURE OF THE INVENTION

An airport surface detector and control system to detect aircrafts and/or vehicles and/or other objects moving on concerned pathways of the airport, including at least a Central Processing Unit and Central Surveillance/Control Unit characterized by comprising:
a) at least a laser-scanning head at the entry of said pathways, and able to cooperate to identify the moving object on its pathway, integrated by
b) a plurality of ground laser-detector units distributed along the pathway and placed one in front of the other and wherein:
each ground detector unit contains at least a laser emitter or a laser receiver,
one laser ray is emitted from each head against the other head, in a parallel close way, in order to be able to detect interruption of one and/or the other laser-ray.

### Advantages

The ground traffic tracking system according to the present invention has been developed with scalability and flexibility in mind, in order to be adoptable by airports of any size, and without the need for collaboration by any of the possible objects of concern (aircrafts, trucks, other moving objects, people, mammals, etc.) and even with no visibility (i.e. the system works during the night and during inclement weather like fog and rain).

### BRIEF DESCRIPTION OF THE DRAWINGS

The invention will be described with the enclosed drawing disclosing some examples of realization, wherein:

FIG. 1 shows a plan view of the ground system applied on a runway or taxi-way

FIG. 2 shows in a schematic plan view the application and workings of a couple of ground detector heads for detecting presence/speed/direction of the wheels of an aircraft. Twin GD units are used to improve reliability and ease of use. As a moving object (in this example, landing gear) enters the lines of sight, the system is activated and measures presence, speed and directions of the entity.

FIG. 3 represents a plan view of a clustering network of GDs. GD's with four double heads are used to build up a network: in this pattern (scheme a), area coverage is provided as well as speed and direction measurement. Scheme b): GD's with four simple heads are tiled in order to cover an area with presence detection only, useful, for example, on green areas around the airport to detect potential intrusions.

FIG. 4 represents a section plane of a GSS hosted by a light fixture. The optical scanner is on the left, and scans through a window; the electronic circuits are on the right, and a thermometer and a resistor are also included to keep the unit thermostatic.

FIG. 5 represents an example of a real-time virtual 3D environment which can be displayed on CSU's and PVU's. Any point of view can be simulated.

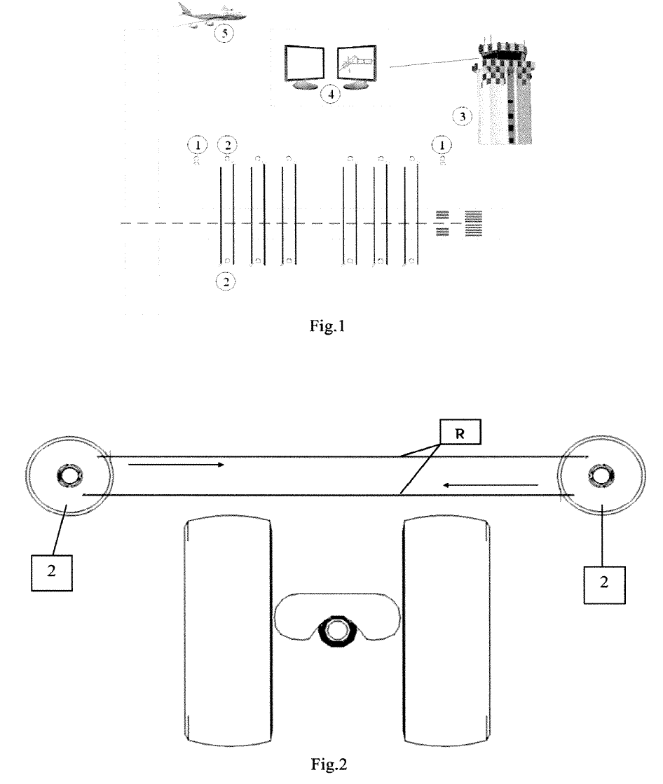

### DETAILED DESCRIPTION OF THE INVENTION

According to the drawings and to the appended claims, the general system composition is the following:
(1) Ground Scanning Systems (GSS), located at critical points on runways and taxiways and able to scan the moving object to allow its detection, measurement and classification;
(2) Ground Detector (GD) Units that work in conjunction with each other, at least one of which hosting a laser-emitter and at least one of which hosting a laser-receiver to enable the measurement of presence and speed. GD's are located along runways and/or taxiways and/or at a given step;
(3) An interconnecting network;
(4) Central processing unit(s) (or CU) and surveillance/control units (CSU);
(5) Peripheral units (PVU) as appropriate, within ground support facilities or on board aircraft, interconnected via radio link and/or broadcast.

All the units have a certain degree of processing power and specific data processing procedures installed.

The main processing software installed on the central processing unit(s) gathers and processes all the incoming data, integrates it with any existing information, and provides the visualization to surveillance units, where control actions can be executed by personnel (such as pilots and air traffic controllers).

Working Structure:
1) GSS are located at critical sections, such as the runway beginning and end or at turns.
2) GD's give continuous coverage of runways and taxiways.
3) The CU is located at the ATC tower.
4) CSU's in use to display data and alarms.
5) PVU's can be used in cockpits to display the same information (or part thereof) as shown on CSU's.

### System Specifications

In the following the most important specifications will be articulated for the components of the presented system.

Since the system has a modular nature, some components are required for it to work while some are optional. Optional components work only if the main system has already been implemented. Each component is described as required or optional.

### Ground Scanning System (1)

The optional Ground Scanning System is used to determine the 2D or 3D shape of an object passing in front of it.

This is accomplished with an optical system able to measure at least some key points of the shape for the purpose of identifying at least one of the following:
the category of the entity (airliner, GA aircraft, truck/GSU, car, person, animal)
the model of the entity (in case of aircraft or vehicles), this being accomplished either with an absolute measurement or with a parametrized measure:
i) in the first case the category and/or the model being determined by matching the measurement with a library of absolute dimensions;
ii) in the second case the relative measurements being compared against a parametric database.

In both cases, the database is preloaded either in the GSS or in the CU and is structured in such a way as to minimize the processing requirements in order to deliver near real-time outputs.

GSS's are provided with a network interface, which can either be cabled or wireless, in order to communicate with the Central Processing Unit.

GSS's can be hosted in an independent case or in existing light cases.

GSS's can optionally be thermostatic in order to keep the same temperature even in varying climate conditions.

GSS's can be always-on or activated by a controlling GD.

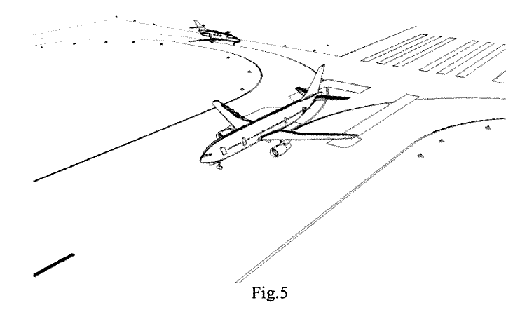

As disclosed in FIG. 4 The GSS optical scanner is scans through a window the runaway or Taxi-way, the electronic circuits are on the right, and a thermometer and a resistor are also included to keep the unit thermostatic.

### Ground Detector (2)

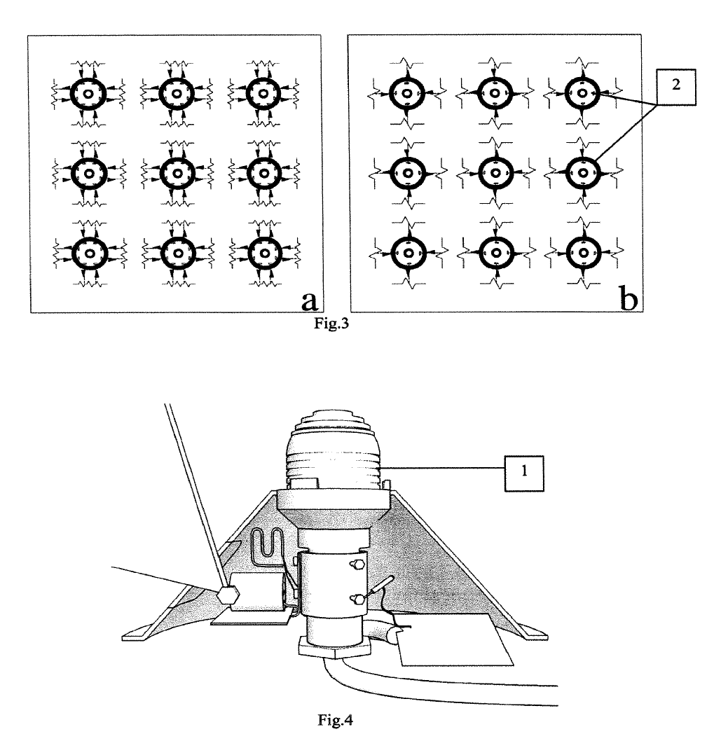

The scheme of a dual GD configuration is clearly disclosed in FIG. 2.

Twin GD units are used to improve reliability and ease of use. As a moving object (in this example, landing gear) enters the lines of sight, the system is activated and measures presence, speed and directions of the entity.

This required component identifies the presence and/or speed and/or direction of an object passing through its optical axis.

It consists of an optical switch or distance meter that measures one or more of the following:
the interruption or the continuity of the optical segment;
the distance of the interrupting object;
the time (relative or absolute) of the interruption.

The component can be configured as:
a single element (with or without a reflector);
an active part separated from its receiver; or
rotating/oscillating meters.

A simple GD can be used to detect the interruption of the optical segment in order to signal a crossing or intrusion.

A GD can be placed at various heights for the purpose of determining different types of entities.

Two or more GD's can be paired or coupled at a known distance in order to measure the speed and the direction of a moving object.

GD's can be made fully modular, with one or more emitting optics and one or more receiving optics. In that way it's possible to accomplish any of the following configurations.

Alternative Clustering network can be applied

Similarly to the previous configuration, a multi-head GD can provide the basis for a network, in which each node is formed by a four-head GD and mutually interconnects to other similar units. In this way area coverage is accomplished.

In case of multiple interconnected GD, the timing reference should be common at least to all interconnected units in order to allow for a precise computation of speed.

GD's are provided with a network interface, which can either be cabled or wireless, in order to communicate between themselves and the Central Processing Unit.

GD's can be hosted in an independent case or in existing light cases.

GD's can optionally be thermostatic in order to keep the same temperature even in varying climate conditions.

FIG. 3 clearly represents a scheme of two GD network configurations.

Scheme a): GD's with four double heads are used to build up a network: in this pattern, area coverage is provided as well as speed and direction measurement. Scheme b): GD's with four simple heads are tiled in order to cover an area with presence detection only, useful, for example, on green areas around the airport to detect potential intrusions.

Advantageously a plurality of ground laser-detector heads (2) is distributed (FIG. 2) along the pathway and placed one in front of the other and wherein:

each ground detector unit contains at least a laser emitter and a laser receiver,

one laser ray is emitted from each head against the other head, in a parallel close way, in order to be able to detect interruption of one and/or the other laser-ray (R).

### The Central Unit (3) or Central Processing Units

The Central Unit (CU) or Central Processing Units represents the main data-collecting and processing facility, and is provided with one or more network interfaces, one or more computers, and a software suite. This software suite is able to receive and process all incoming data from all networked GD's and GSS's, to identify:
critical situations;
possible collision paths;
intrusions;
aircraft taking the wrong runway or taxiway;
excessive or inadequate speeds on runways during takeoff or landing;
excessive speeds of vehicles or aircraft on taxiways;

Furthermore the CU takes charge of the production and availability of all the data required by the CSU's and by PVU's. It also actively sends critical data (for alerts and alarms) to selected CSU's and PVU's.

The CU will also be able to assume and integrate in its algorithms existing safety measures, such as real time fleet position reports, radar data output, S-mode feeds, etc.

### Central Surveillance/Control Unit (4)

The Central Surveillance/Control Unit (CSU) is the human interaction interface of the system, as it provides information and receives commands from system operators.

Provided information comprises:
overview of the airport area;
overview of all aircrafts movements;
dynamic details and ID of every aircraft;
overview of all vehicles moving on controlled paths;
dynamic details and classification of vehicles;
overview of possible intrusions;
follow up of intrusions;
critical situations;
overview of possible collision paths;
time and spatial details of possible collision paths;
aircrafts taking the wrong runway or taxiway;
excessive or inadequate speeds on runways during takeoff or landing;
excessive speeds of vehicles or aircraft on taxiways;

All situations listed above can trigger audible and/or visual alarms, either at the CSU or on remote devices.

The CSU can be interfaced to existing ATC networking, devices and protocols.

By knowing the geometry of the airport surface, and with the real-time acquisition and processing (performed by the CU) the CSU can display the situation of the airport surface in a virtual 3D environment.

Also, emergency situations can be chromatically displayed. For example, a given aircraft on a colliding path can be shown in flashing red. Peripheral Visualization Unit (5)

Similarly to the CSU, information relevant to a single aircraft/vehicle/GSE can be sent to (or requested by) a Peripheral Visualization Unit or PVU (5), which is made up of a CPU, a display, and an acoustical system. It functions as an interface to convey information to the pilot/driver/field operator.

PVU's can be used to visualize the whole airport area in a virtual way, in order to find out dynamic information about specific points, vehicles and aircrafts.

In particular, PVU's can be used by pilots during take-off and landing operations in order to visualize the actual status of the runway prior to the beginning of the operation. In this way pilots can make sure that there are no other aircraft or objects on the assigned runway, no aircrafts or vehicles in colliding paths and no incursions. In this case, they can safely decide to go on. Otherwise, they can postpone the operation and, for example, delay the TO, or regain height instead of landing.

As an additional benefit, PVU's can be used not only to display real-time information, but also to visualize how the situation will evolve in the next few moments, so the pilot can test, for example, if the runway will still be free from other aircraft and vehicles at the time he will be actually landing or taking off.

This can be accomplished either in a direct way (i.e. visualizing a specified predicted time frame) or in a fast-forward fashion (i.e. visualizing the predicted evolution of a given time span in a shorter-than-real time).

All the above operations can of course be performed at the ATC through the use of a CSU.

The data transfer to PVU's takes place via radio over an encrypted protocol (to prevent information sniffing by third parties) and each PVU receives only the pertinent information (for example only the present status and predicted evolution of the runway the flight is assigned to). This achieves the minimization of the required transmission bandwidth and keeps the delivered information to the minimum required.

On-field operators can use PVU's in order to locate intrusions or as a way to receive information and instructions from the ATC.

Similarly, vehicle drivers can use PVU's to verify their assigned paths and decide what action to take. This is particularly useful during emergencies.

The advantages of the invention can be summarized as follows:
The ability to detect presence, movements, speed and direction of objects on runways, taxiways and peripheral areas by means of modular, distributed elements, even in low-visibility or no-visibility conditions.
The ability to identify aircrafts and vehicles by acquiring their shapes with an active, non-invasive system.
The ability to follow aircraft and vehicles as they move along a path.
The ability to identify potential collision paths based on the information derived from the previous steps.
The ability to display comprehensive information about movements on the airport surface at various levels of detail.
The ability to set off an alarm in case of potential danger.
The ability to identify incursions by means of non-invasive active elements.
The ability to predict the short-term evolution of the location, speed, and direction of any detected object on the airport.
The ability to transmit processed information to remote units and to display the present and predicted status of the airport.
The ability to visualize in a fast-forward fashion the short term evolution of the airport, both in the ATC and on remote units.

Advantageously, said laser-scanning head (1) and said ground laser-detector (2) have an height not more than 50 cm, preferably 30 cm. In this way no trouble is caused to and no danger constitutes for the vehicles.

1. An airport surface detector and control system to control aircrafts and/or vehicles and/or other objects moving on interested pathways of the airport, comprising at least a Central Processing Unit and Central Surveillance/Control Unit characterized by comprising:
a) at least a laser-scanning head at the entry of said pathway, and able to co-operate to identify the moving object on its pathway, followed by
b) a plurality of ground laser-detector heads distributed along the pathway and placed one in front of the other and wherein:
each ground detector unit contains at least a laser emitter and a laser receiver,
one laser ray is emitted from each head against the other head, in a parallel close way, in order to be able to detect interruption of one and/or the other laser-ray.

2. An airport surface detector and control system according to claim 1 characterized in that it is further provided with means to communicate with peripheral units installed in a vehicle that is approaching the controlled area.

3. An airport surface detector and control system according to claim 1 characterized in that said laser-scanning head is an active optical system able to measure at least some key points of the shape for the purpose of identifying at least one of the following:
the category of the entity
the model of the entity,
this being accomplished either with an absolute measurement or with a parameterized measure:
i) in the first case the category and/or the model being determined by matching the measurement with a library of absolute dimensions;
ii) in the second case the relative measurements being compared against a parametric database.

4. An airport surface detector and control system according to claim 1 characterized in that said ground laser-detector is formed by two emitting heads and two receiving heads, mutually interconnected to other similar units in cross direction.

5. An airport surface detector and control system according to claim 1 characterized in that said ground laser-detector is formed by a four double-heads and mutually interconnects to other similar units in cross direction.

6. An airport surface detector and control system according to claim 1 characterized in that said laser-scanning head and said ground laser-detector have an height not more than 50 cm.

7. An airport surface detector and control system according to claim 1 characterized in that said laser-scanning head and said ground laser-detector have an height not more than 30 cm.
